(19) United States
(12) Patent Application Publication
(10) Pub. No.: US 2002/0127372 A1
(43) Pub. Date: Sep. 12, 2002

(54) Floor and wall coverings employing decorative substrate materials

(76) Inventors: Matthew J. Waite, Allentown, PA (US); Bruce Terwilliger, New Paltz, NY (US)

Correspondence Address: NORRIS MCLAUGHLIN & MARCUS, P.A., P O BOX 1018, SOMERVILLE, NJ, 08876

(21) Appl. No.: 10/143,339

(22) Filed: May 9, 2002

Related U.S. Application Data
(62) Division of application No. 09/651,446, filed on Aug. 30, 2000.

(51) Int. Cl. B32B 3/00; B05D 5/00; B29C 37/02

(52) U.S. Cl. 428/172; 428/203; 427/258; 264/138

(57) ABSTRACT

A surface covering, particularly a sheet vinyl floor or wall covering, wherein a decorative wet laid felt sheet is employed to impart decorative effects to the finished product. The decorative felt sheet is overlaid at least with a translucent wearlayer and optional decoration can be provided by printing, decorative particles, mechanical and/or chemical embossing and combinations thereof.

### BACKGROUND OF THE INVENTION

1. Field of the Invention

The present invention has to do with decorative surface coverings, such as sheet vinyl floor and wall coverings, employing decorative substrate materials which have not previously been used in surface coverings. According to the invention, decorative felt substrates are used to provide all or a portion of the decorative effects in sheet vinyl surface coverings. The invention relates further to methods of manufacturing the felt substrates and surface coverings.

2. Description of the Related Art

The current method of preparing decorative surface coverings by coating methods is multi-step process. It utilizes a substrate which is either printed or coated (or both) to provide decorative effects. A protective clear coating is then applied over this decoration to prevent damage to it during its use as a surface covering. Various intermediate steps are often taken to add such effects as surface texture (through chemical or mechanical embossing means, or both) or an inlaid or other three-dimensional appearance (by the inclusion of decorative elements within overlaying layers). Many products have been made employing particles as decorative material such as U.S. Pat. No. 4,212,691 which discloses depositing decorative chips on a liquid plastisol layer, embedding the chips, gelling the plastisol and then applying a wearlayer. Similar process employing other types of decorative particles are disclosed in U.S. Pat. No. 5,571,588 and the combination of particles and printed patterns is disclosed in U.S. Pat. No. 4,794,020. Of course, the use of printed patterns applied by conventional means has been a part of the surface covering art for many years. Other processes used in the preparation of surface coverings are well known and include, for example, the use of extrusion lamination with a clear film, such as EVA.

A great deal of cost is incurred because of the necessity of multiple passes through the various processes or, alternatively, the expense of constructing a production line capable of performing the requisite steps in fewer passes. Reducing the number of process steps required to produce the decorative surface covering would reduce its cost and the number of steps can be reduced according to the present invention.

A common substrate used to produce surface coverings is a fibrous sheet in the form of a water-laid web, also called wet-laid felt products, which have been manufactured for many years and have been used in various applications including substrates for sheeted floor and wall coverings.

Current production methods for making composite sheets of felt are a part of the papermaking art and can employ handsheet forming apparatus or, more commonly, continuous papermaking equipment such as a Fourdrinier machine, a cylinder machine, suction machines such as a Rotaformer, millboard equipment and modified versions of such equipment. The production methods are variously set forth in the patent literature and a good narration is provided in U.S. Pat. No. 4,225,383, the specification of which is incorporated herein by reference.

In general terms, the process involves preparing an aqueous dispersion of a water-dispersible fiber or blend of fibers (e.g., cellulose, synthetics and fiberglass) and inorganic materials such as clays. These materials are blended in a high speed mixer such as a hydropulper. The aqueous dispersion is then transferred to a blending tank provided with a continuous mixer. A latex binder is added to the blending tank followed by a flocculent or coagulant which is added in sufficient quantity to colloidally destabilize the resulting mixture. When the mixture has been destabilized, a fibrous agglomerate is formed, which is known in the art as a furnish. The furnish is transferred to a continuously mixed holding tank as a machine chest. From the machine chest, the furnish is applied to a woven mesh belt (also called a wire or forming fabric). A flocculent can be added to the furnish prior to application of the furnish to the belt in order to enhance water drainage and solids retention. Water is drained from the furnish, the damp felt then is removed from the belt and it is dried. Coatings can be applied to the surfaces of the dried or partially dried felt and the end product is taken up on a roll.

Flexible felt materials are employed as substrates in the manufacture of sheet vinyl surface coverings such as floor and wall covering materials. The substrate is conventionally coated with layers of vinyl, optionally latex and other materials. Decoration is provided by printing, embedding particles such as chips, flakes and the like in the vinyl, embossing and other conventional techniques. U.S. Pat. No. 5,169,704 describes various combinations of these decorating techniques.

It has now been found in accordance with the present invention that a reduction of required processing steps can be achieved by incorporating the desired decorative effects into the substrate itself. This leaves only the application of a protective coating (such as a wearlayer) as a further required process step to produce a simple, low cost surface covering. Intermediate steps may still be added to provide additional effects as desired, such as surface texture or a different visual appearance.

Accordingly, new design effects can be achieved by employing decorative felt substrates in the manufacture of sheet vinyl surface coverings. The substrate can be used in combination with a clear vinyl wear layer or with other decorative elements such as printing, particles, mechanical embossing and/or chemical embossing to make new products having a unique appearance.

A further advantage of the invention is that the use of thermoplastic design elements can be avoided if desired. Such design elements can melt, spread and smear, resulting in damaged product.

All percentages set forth herein are by weight/weight unless specifically designated otherwise.

### SUMMARY OF THE INVENTION

A wet-laid felt sheet is produced from a combination of a water-dispersible fiber, a film-forming, water-insoluble, organic polymer and an inorganic filler which are mixed with water. An example of the process is illustrated by the following steps wherein percentages are expressed on a dry solids basis:

(I) providing an aqueous dispersion of from about 1 percent to about 30 percent, preferably from about 5 to 15 percent, of a water-dispersible fiber;

(II) mixing therewith

(A) from about 60 percent to about 95 percent, preferably from about 75 to 90 percent, of a substantially water-insoluble, non-fibrous, inorganic filler, and

(B) from about 2 percent to about 30 percent, preferably from about 5 to 15 percent, of a film-forming, water-insoluble, organic polymer in the form of an ionically stabilized latex, i.e., an aqueous colloidal dispersion of a substantially water-insoluble, organic polymer, having not greater than about 0.7 milliequivalent, preferably from about 0.03 to about 0.4 milliequivalent, of bound charge per gram of polymer in the latex;

(III) colloidally destabilizing the resulting mixture to form a fibrous agglomerate in aqueous suspension;

(IV) distributing and draining the aqueous suspension on a porous substrate such as a wire to form a wet web; and

(V) drying the web to make a fibrous sheet which can be used as a substrate for the manufacture of decorative surface coverings.

Decorative effects can be incorporated into this substrate by various means and at various stages of the process as explained in the Detailed Description of the Invention set forth below.

Other design effects can be imparted to the surface coverings of the invention in the layer or layers of material which overlay the decorative substrate. This can be achieved with various combinations of printing, particulate material, mechanical embossing and other techniques known in the art. Chemical embossing also can be employed to obscure some of the decorative features of the substrate and reveal others. This can be accomplished by employing inhibitors to create areas which will remain transparent following expansion of the foam or by using mechanical means to crush an expanded foam and create transparent crushed areas. (See, for example, U.S. Pat. No. 3,978,258.) The combination of design features in the decorative substrate and in the layer or layers overlaying the decorative substrate can be used to make surface coverings having a unique appearance which is new in the surface covering art.

### BRIEF DESCRIPTION OF THE DRAWINGS

FIG. 1 is a fragmentary sectional view of a floor covering material of the invention having a decorative substrate and a clear plastic wearlayer.

FIG. 2 is a fragmentary sectional view of a floor covering material of the invention having a decorative substrate and further incorporating printed decoration and optional overall mechanical embossing.

FIG. 3 is a fragmentary sectional view of a floor covering material of the invention having a decorative substrate and further incorporating particulate decoration and optional overall mechanical embossing.

FIG. 4 is a fragmentary sectional view of a floor covering material of the invention which incorporates printed and particulate decoration and illustrates optional in register chemical embossing and optional overall mechanical embossing.

FIG. 5 is a fragmentary sectional view of a floorcovering material of the invention having a decorative substrate, an optional clear intermediate layer and a chemically expanded and mechanically embossed wearlayer.

In the figures, it is not intended that the thicknesses of the various layers of components shown or sizes or location of particles, printing or embossing are precisely represented. Rather, the various elements are represented on a considerably enlarged scale and without showing precise relationships among the various components.

There are many combinations and permutations of the elements illustrated in the drawings as will be apparent to those skilled in the art.

### DETAILED DESCRIPTION OF THE INVENTION

A preferred embodiment of the present invention is sheet vinyl floor covering and such materials shall be described in the following detailed description. The invention, however, is not limited to floor covering and other decorative surface materials such as wall covering are included within the scope hereof.

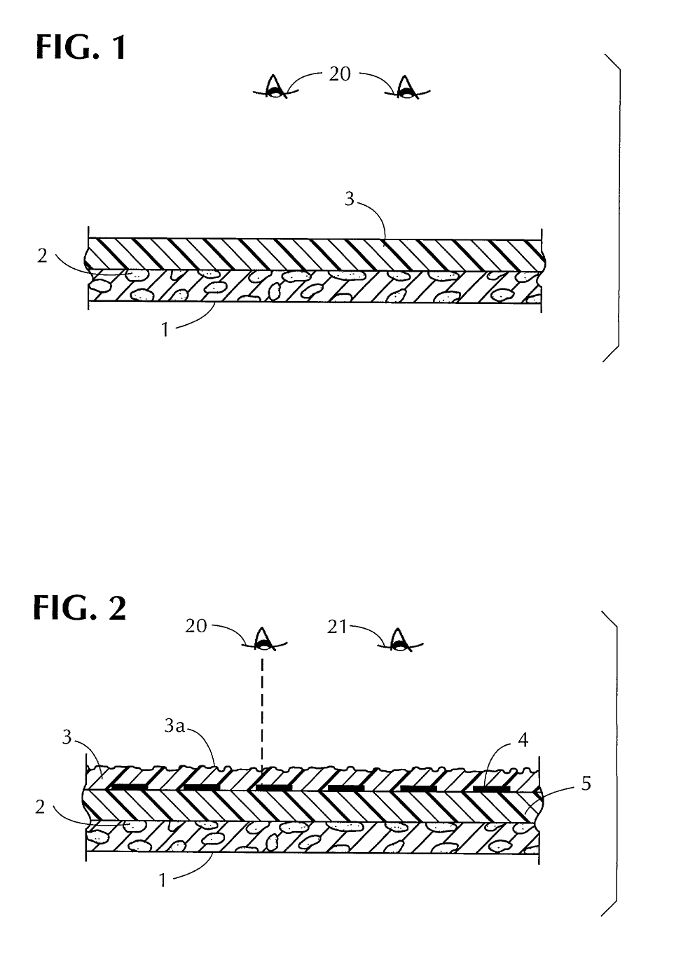

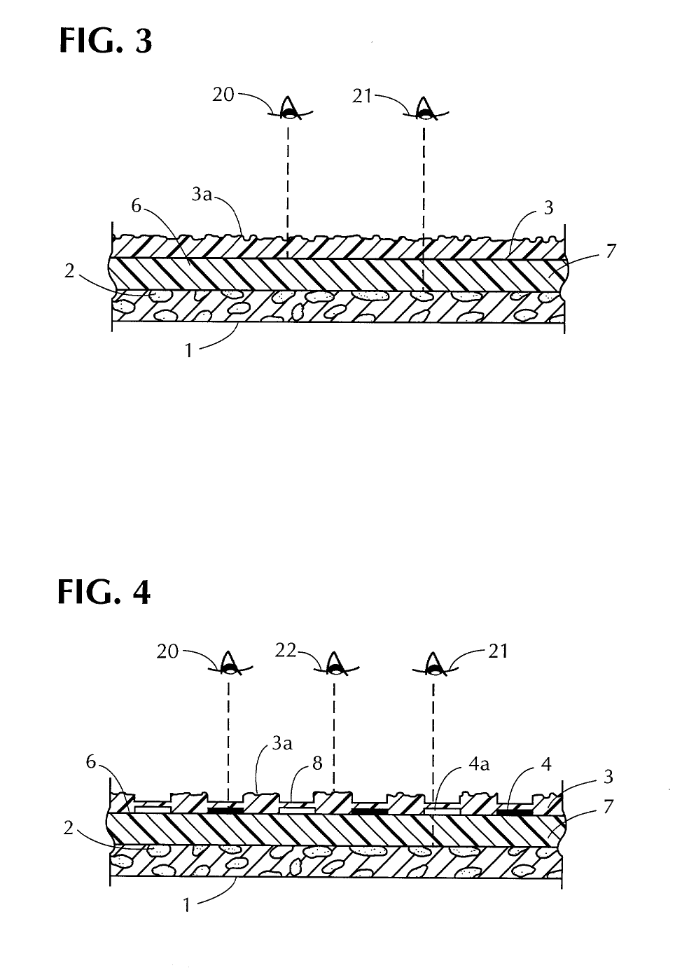

Referring to FIG. 1, the decorative substrate 1 comprises decorative elements 2 therein and the decorative elements on the surface adjacent wearlayer 3 are visible through the wearlayer. The wearlayer can be clear or tinted as long as it is sufficiently translucent for the decorative elements to be visible through the layer as illustrated by eyes 20 which depict the visibility of the decorative elements through the wearlayer. Wearlayer 3 can be mechanically embossed (see FIGS. 2 and 3) and multiple wearlayers can be employed if desired.

FIG. 2 illustrates printed elements 4 of a layer which is printed on a clear smoothcoat layer 5. The decorative substrate is the same as in FIG. 1 and the wearlayer 3 is provided over the printed layer. Overall mechanical embossing is illustrated by texture 3a. There can be more than one printed layer if desired and the printing can be opaque and/or translucent (e.g., tinted). In an alternative embodiment, printing can be done directly on the decorative substrate. When opaque ink is used for printing, it must be applied in a manner which permits at least some of the decorative elements of the decorative substrate to show through. For example, it can be in the form of a pattern with portions that are not printed. Eye 20 illustrates the visibility of a printed portion through the wearlayer and eye 21 illustrates the visibility through the overlayers of decorative elements in the substrate. As noted above, multiple wearlayers can be employed if desired.

In FIG. 3, particles 6 are incorporated in a plastisol layer 7. The decorative substrate is the same as in FIG. 1 and the wearlayer 3 is provided over the plastisol layer 7. Overall mechanical embossing is illustrated by texture 3a. In an alternative embodiment, the plastisol layer 7 can serve as the only wearlayer in which case there would be no wearlayer 3. The particles can be translucent and/or opaque provided that they are applied in a manner which permits at least some of the decorative elements of the decorative substrate to show through. Eye 20 illustrates the visibility of an opaque particle which obscures the decorative elements in the substrate and eye 21 illustrates the visibility through the overlayers of the decorative substrate. Of course, additional wearlayers can be employed, if desired.

The embodiment illustrated in FIG. 4 shows chemical embossing 8 in register with opaque printed elements 4 and transparent printed elements 4a. Particles 6 are illustrated in plastisol layer 7 under the printed layer. Eye 20 illustrates the visibility of a printed opaque ink, eye 21 illustrates the visibility of the decorative substrate through a transparent ink and other layers and eye 22 illustrates the opacity of the chemically expanded portion which has been optionally mechanically embossed. Optional mechanical embossing is accomplished by cooling the expanded product and then mechanically embossing the raised areas, preferably following reheating of the surface of the expanded layer. Alternatively, the particles could be in a layer over the printed layer or both over and under the printed layer. As with the other embodiments, the decorative elements of the decorative substrate must not be completely obscured and additional wearlayers and decorative elements can be employed if desired.

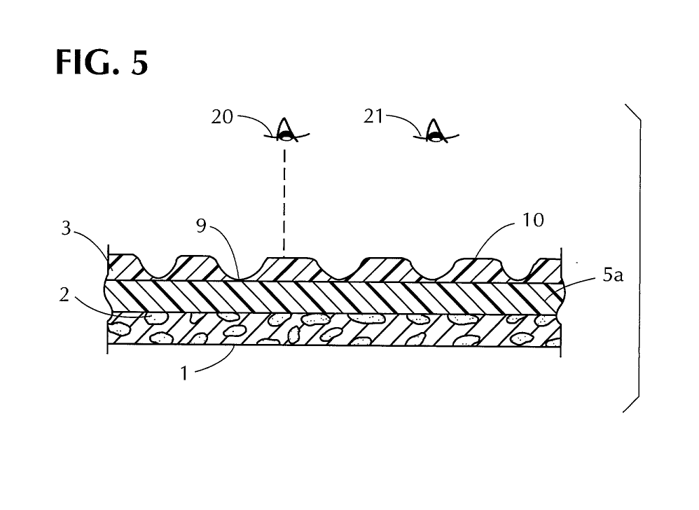

The embodiment illustrated in FIG. 5 has a chemically expanded wearlayer 3 which was mechanically crushed by an embossing roll in areas 9. The decorative elements 2 are visible through areas 9 but they are obscured in areas 10 due to the opacity of the chemically expanded portions that were not crushed. Eye 20 illustrates the opacity of the chemically expanded portion and eye 21 illustrates the visibility of the decorative substrate through the mechanically crushed portion. This embodiment can be subject to further mechanical embossing of the expanded portions by cooling the product to near ambient temperature and then mechanically embossing the raised portions. This is not illustrated in FIG. 5 but the appearance would be like the mechanically embossed portions illustrated in FIG. 4. Of course additional wearlayers and other decorative elements can be employed.

Other variations on the foregoing will be apparent to those skilled in the art in light of the above description and the following detailed treatment of the various elements and methods of the invention.

### DECORATIVE SUBSTRATE

The substrate is manufactured using conventional equipment for felt manufacture such as a Fourdrinier machine and the process is described in U.S. Pat. No. 4,225,383 as noted above.

In a preferred embodiment water is added to a high speed mixer such as a hydropulper and, with continuous mixing, a water dispersible fiber is admixed with the water to provide an aqueous dispersion of from about 1% to about 30%, preferably from about 5% to about 15%, based on dry solids, of a water-dispersible, but water insoluble fiber. Then a finely-divided, substantially water insoluble, non-fibrous inorganic filler in an amount from about 60% to about 95%, preferably from about 70% to about 90%, based on dry solids, is admixed in the hydropulper to prepare a first dispersion. The first dispersion is pumped to a blending tank along with additional water to reduce solids content to about 6 percent and, with continuous mixing, a binder containing a film-forming, water-insoluble, organic polymer in the form of an ionically stabilized latex is added in an amount from about 2% to about 30%, preferably from about 5% to about 15% based on dry solids. This is followed by adding a flocculent in an amount from about 0.06% to about 0.18%, based on dry solids, to form a fibrous agglomerate. The fibrous agglomerate then is pumped to a mixing tank such as machine chest and it is continuously mixed and held in the machine chest until it is needed. Then additional flocculent is added in an amount from about 0.04% to about 0.12%, based on dry solids, to colloidally destabilize the resulting mixture and complete preparation of the furnish. The furnish is then applied to a continuous mesh belt (also known in the art as a web).

The mesh belt moves continuously and water drains from the furnish through the mesh belt until a wet felt is formed having sufficient strength to be lifted from the belt. The wet felt is pressed by press rolls to squeeze moisture out of the wet felt and the pressed felt is taken through a continuous dryer comprised of steam heated drums. The dried felt is taken up on a roll.

The fiber used according to the invention can be any water insoluble, natural or synthetic water-dispersible fiber or blend of such fibers. Either long or short fibers, or mixtures thereof, are useful and mixtures of various types of the fibers listed below can be used. Many of the fibers from natural materials are anionic, e.g., wood pulp. Some of the synthetic fibers are treated to make them slightly ionic, i.e., anionic or cationic. Glass fiber, chopped glass, blown glass, reclaimed waste papers, cellulose from cotton and linen rags, mineral wool, wollostonite, synthetic wood pulp such as is made from polyethylene, straws, ceramic fiber, nylon fiber, polyester fiber and similar materials are useful. Particularly useful fibers are the cellulosic and lignocellulosic fibers commonly known as wood pulp of the various kinds from hard wood and soft wood such as stone ground wood, steam-heated mechanical pulp, chemimechanical pulp, semichemical pulp, and chemical pulp. Specific examples are unbleached sulfite pulp, bleached sulfite pulp, unbleached sulfate pulp and bleached sulfate pulp.

The inorganic fillers which can be used in the practice of the invention are finely-divided, essentially water-insoluble, inorganic materials. Such materials include, for example, titanium dioxide, amorphous silica, zinc oxide, barium sulfate, calcium carbonate, calcium sulfate, aluminum silicate, clay, magnesium silicate, diatomatious earth, aluminum trihydrate, magnesium carbonate, partially calcined dolomitic limestone, processed volcanic mineral, magnesium hydroxide, and mixtures of two or more of such materials.

The binder which can be used according to the invention is a film-forming, water-insoluble, organic polymer which is natural or synthetic and may be a homopolymer, a copolymer of two or more ethylenically unsaturated monomers or a mixture of such polymers. Particularly for ease of processing to make the product and for limiting the loss of pollutants to the surroundings, it is generally advantageous that the polymer is in the form of a latex, i.e., an aqueous colloidal dispersion. Representative organic polymers are acrylics, polyvinyl acetates, ethylene vinyl acetates, natural rubber, the synthetic rubbers such as styrene/butadiene rubbers, isoprene rubbers, butyl rubbers and nitrile rubbers and other rubbery or resinous polymers of ethylenically unsaturated monomers which are film-forming, preferably at room temperature or below, although in a particular instance a polymer may be used which is film-forming at the temperature used in preparing that sheet. Non-film-forming polymers may be used in blends provided that the resulting blend is film-forming. Polymers which are made film-forming by the use of plasticizers also may be used. The binders preferably have some ionic hydrophilic groups but must be devoid of sufficient non-ionic colloidal stabilization which would interfere with formation of-the fibrous agglomerate. Such non-ionic, colloidal stabilization could be provided by non-ionic emulsifiers or by the presence of copolymerized monomers having the kinds of hydrophilic groups that are found in nonionic emulsifiers, for example, hydroxyl and amide groups. Thus, if monomers having such hydrophilic groups are polymerized constituents of the latex polymers, such monomers will be present in small proportion such as less than about 10%, usually less than about 5% of the polymer weight for best results. Also, while very small amounts of non-ionic emulsifiers can be tolerated in some compositions, their use ordinarily is not advantageous and they should not be used in amounts sufficient to interfere with the destabilization step of the process.

The flocculent is a water-dispersible, preferably water-soluble, ionic compound or polymer, i.e., compounds or polymers having a positive or a negative charge. The flocculent selected for use according to the invention ordinarily will have a charge opposite in sign to the binder. If the binder has a negative charge, the flocculent will have a positive (cationic) charge and vice versa. However, when combinations of two or more flocculating agents are used, not all of them are necessarily opposite in charge to the initial charge of the latex.

Representative flocculants are cationic starch; water-soluble, inorganic salts such as alum, aluminum sulfate, calcium chloride and magnesium chloride; and ionic latex having a charge opposite in sign (+) to that of the binder latex, e.g., a cationic latex or an anionic latex; water-soluble, ionic, synthetic, organic polymers such as polyethylenimine and various ionic polyacrylamides such as carboxyl-containing poly-acrylamides; copolymers of acrylamide with dimethylamino-ethylmethacrylate or diallyldimethyl ammonium chloride; polyacrylamides modified other than by copolymerization to have ionic groups; and combinations or two or more of the above, added simultaneously or in sequence. Quaternized polyacrylamide derivatives are especially advantageous when the binder which is used is anionic. Polymeric flocculants are preferred because they are more efficient, tend to produce less water sensitive products and provide better shear stability of the furnish.

Decorative effects can be incorporated into this substrate by a variety of means, including but not limited to:

1. Mixing decorative materials to the aqueous dispersion of step (I) above.

2. Mixing decorative materials into the aqueous dispersion of step (II).

3. Mixing decorative materials into the colloidally destabilized aqueous suspension of step (III).

4. Distributing decorative materials along with the destabilized aqueous suspension as it is distributed on a porous substrate in step (IV).

5. Distributing decorative materials onto the wet web formed in step (IV).

6. Any combination of two or more of the foregoing.

The selection requirements for appropriate decorative materials differ depending on which mode of addition is chosen, due to the differences in conditions (degree of shear, filtration, etc.) experienced in each step in the process as would be apparent to those skilled in the art having the benefit of this disclosure.

Appropriate decorative materials must satisfy a variety of requirements related to the processes used to incorporate the decorative materials into the fibrous sheet, the processes and materials used to convert the substrate into a finished surface covering, and the in-use performance requirements of the finished surface covering.

These requirements include, but are not limited to,

Resistance to materials and processes used in forming the decorated fibrous sheet including the following:

Resistance to fracture or breakdown from mechanical processes;

Resistance to dissolution, color bleed or fade in aqueous-dispersion;

Resistance to ionic and/or pH conditions existing in the aqueous dispersion; and

Resistance to degradation from elevated temperatures in the drying process.

Resistance to materials and processes used to convert the decorated fibrous sheet into a finished surface covering including the following:

Resistance to damage from resins, plasticizers, stabilizers, antimicrobial agents, and other ingredients;

Resistance to color bleed into the overlaying protective layers;

Resistance to degradation from elevated temperatures in the fusing process; and

Resistance to high intensity ultraviolet radiation commonly used to cure certain protective coatings.

In-use performance requirements including the following:

Resistance to mechanical breakdown from i.e. pedestrian traffic, rolling loads, etc.;

Resistance to color change, fading, or bleeding,Resistance

Resistance to alkaline conditions; and

Resistance to UV exposure.

One embodiment of the present invention involves the incorporation of varying colored fragments of previously-manufactured fibrous sheets into a fibrous sheet which is then used as a decorative substarate to make a finished surface covering material. One advantage of this method is that many of the performance parameters of these fragments are already known from the materials' long-time use as a substrate for surface coverings. Selection of appropriate coloring ingredients such as dyes or pigments is all that is required to ensure a satisfactory product. The coloring of the original fibrous sheet can be done either during its original manufacture, or at some point thereafter, either before or after its conversion to suitably-sized fragments.

Other embodiments involve the inclusion of a myriad of decorative materials in the substrate, including, but not limited to, colored fibers, particles, granules, chips, flakes, etc., made of plastic, wood, metal (or metallized materials), paper, minerals, etc. and selected so as to satisfy the above-listed performance requirements.

In the most basic embodiment of the invention, the decorative substrate material described above is overlaid with a liquid plastic layer which forms a clear wearlayer following heating to cure the plastic and fuse the product.

### Wearlayer/Plastisol Layer

As noted above, in the most basic embodiment of the invention, a clear, liquid plastisol layer is applied over the surface of the decorative felt substrate followed by sufficient heating to cure the plastisol and fuse the product. The fused layer provides a transparent wearlayer and the decorative substrate is visible through the wearlayer. Other clear films can be used as wearlayers and other methods such as infrared curing and the like can be used as would be apparent to those skilled in the art.

As used herein the term “plastisol” is generally-intended to cover a relatively high molecular weight PVC resin dispersed in one or more liquid plasticizers. The plastisol upon heating or curing forms a tough flexible solid. For purposes of this specification, plastisol compositions are also intended to include organosols, which are similarly dispersed PVC resin materials that, in addition, contain one or more volatile liquids which are driven off upon heating. Preferably, the wearlayer employed according to the invention is a clear, unfilled, resinous polymer composition such as a PVC plastisol.

Although the preferred plastisol layer is a PVC homopolymer resin, other vinylchloride resins can be employed. Exemplary are vinylchloride-vinylacetate copolymers, vinylchloride-vinylidinechloride copolymers and copolymers of vinylchloride with other vinyl esters, such as vinylbutyrate, vinylpropionate and alkyl substituted vinyl esters, wherein the alkyl moiety preferably is lower alkyl containing between about 1-4 carbons. Other suitable synthetic resins such as polystyrene, substituted polystyrene (preferably wherein the substituents are selected from the group consisting of alkyl having 1-10 carbons preferably 1-4 carbons, and aryl having 6-14 carbons), polyolefins such as polyethylene -and-polypropylene, acrylates and methacrylates,-polyamide, polyesters and any other natural or synthetic resin.

The composition of the plastisol layer must be compatible with the underlying substrate and must be otherwise compatible with the overall product composition and, therefore, within the principles of this invention. Thus it is not essential that a plastisol always be used. Organosols and clear aqueous latexes are also of use, employing as the dispersing or suspending media, organic solvents and water, respectively, rather than plasticizers as in the case of a plastisol.

When the preferred plastisol is employed, typical plasticizers which can be used are dibutyl sebacate, butyl benzyl sebacate, dibenzyl sebacate, dioctyl adipate, didecyl adipate, dibutyl phthalate, dioctyl phthalate, dibutoxy ethyl phthalate, butyl benzyl phthalate, dibenzyl phthalate, di(ethylhexyl) phthalate, alkyl or aryl modified phthalate esters, tricresyl phosphate, octyl diphenyl phosphate, dipropylene glycol dibenzoate, dibasic acid glycol esters and alkyl aryl or alkyl aryl hydrocarbons and the like.

Those skilled in the art will appreciate that in addition to the basic resin constituents, other commonly employed constituents can be present in plastisols. These can include conventional stabilizers/accelerators initiators, catalysts, etc., such as zinc oleate, dibasic lead phosphite etc., conventional heat or light stabilizers, such as metallic soaps, etc., ultraviolet absorbers, solvents and diluents, such as xylene, mineral spirits, dodecyl benzene, etc., viscosity modifiers, antioxidants, bacteriostat and the like.

The plastisol layer is substantially uniformly applied in its liquid state to the underlying surface by conventional means such as a knife-over roll coater, direct roll coater, rotary screen, draw down bar, reverse roll coater or wire wound bar. The particular means for applying the layer does not relate to the essence of the invention, and any suitable coating means can be employed.

The thickness of the liquid plastisol layer as it is applied to the underlying surface is substantially uniform and is in the range from about 3 to about 30 mils, preferably from about 6 to about 16 mils. The layer can be thicker or thinner as may be required by the particular product application. If the floor covering-product is to be mechanically embossed, however, the layer must be thick enough to allow embossing.

### Printed Layer or Layers

Suitable printing inks include those normally used in the manufacture of floor covering. These include plastisol or solvent-based systems and water-based systems. Ultraviolet curable printing inks can also be used.

The printing ink may include organic pigments or inorganic pigment particles such as titanium dioxide, chromium dioxide, cadmium sulfide, iron oxide, carbon black, mica and the like. Decorative reflective particles may also be included as part of the printing ink composition or may be separately applied either randomly or by selective deposition in the form of a pattern or design.

Printing can be effected by rotogravure, flexigraphic, screen printing, pad or knurled printing, or other printing techniques conventionally employed in making floor or wall covering products.

### Decorative Particles

Various types of decorative particles of the kind conventionally employed in floor covering can be used to achieve desired design effects. These include chips, flakes, spheroidal particles and the like. The particles can be comprised of various homogeneous or heterogeneous organic or inorganic materials or mixtures thereof and can be translucent or opaque. Suitable particles can be made from any one or a combination or mixture of mica, ceramics, metals, rubbers, and polymeric and resinous compositions such as acrylics, plastisols, polyamide, polyolefins, polycarbonates, polyvinyl chloride and copolymers thereof and polyesters. Each particle can contain its own individual colorant, dye or pigment or they can be uniformly colored.

Methods of incorporating particles in a plastisol layer are well known in the art and they can be incorporated before the layer is applied to a substrate or afterward while the plastisol is still in its liquid state.

### Smoothcoat Layer

The smoothcoat layer can be made from the same material as is used in the plastisol layer. As with the plastisol layer, it is preferably a clear layer but it can be slightly tinted. The smoothcoat layer is optional and it is used when it is desirable to provide a smooth surface for the printed layer.

The thickness of the smoothcoat layer, as it is applied in its liquid, tacky ungelled state to the underlying surface, is substantially uniform and is in the range from about 2 to about 18 mils, preferably from about 4 to about 12 mils. The layer can be thinner or thicker as may be required by the particular product application, as long as it is thick enough to provide enhanced surface characteristics for printing.

### Gelling and Fusing

When one plastisol wearlayer is employed, the decorative substrate and liquid plastisol are heated at a temperature and for a sufficient time to cure the plastisol and fuse the product. However, when more than one plastisol layer is employed, after each layer is applied it is heated at a temperature and for a sufficient time to gel the layer without fully curing it or fusing the product. After all plastisol layers are applied the product is fused. The times and temperatures for gelling and fusing will depend upon the compositions of the plastisols, thickness and other factors well known to those skilled in the art.

### Urethane Wearlayer

Polyurethanes can also be used for the wearlayer in accordance with the invention. They can be used instead of plastisol or as an additional wearlayer (or wearlayers). A smooth coating of polyurethane can be applied using the same techniques as those used to apply smooth coatings of plastisol except where the surface is embossed; in which case it would be preferable to use a direct roll coater or an air knife coater. Polyurethane can also be applied by laminating it onto another substrate and applying it to a surface with an adhesive or by means of a heat and pressure laminating process.

Depending upon the chemistry of the polyurethane, the polyurethane layer can be cured by heat, chemical reaction, ultraviolet light or electron beam radiation. A preferred means is high energy ultraviolet light.

The cured polyurethane layer can be from about 0.1 to abbout 10 mils thick and is preferably from about 0.25 to about 4 mils thick. Additional layers of polyurethane can be used if desired. The product can be fused before or after application of the urethane wearlayer.

### Flame Retardants and Smoke Suppressants

Conventional flame retardants and smoke suppressants which are compatible with the various materials used in accordance with the invention can be added at any stage of the process. They can be impregnated into the substrate and/or admixed with any one or a combination of the plastisol or urethane layers. Resinous particles and other types of particles containing such compositions can also be manufactured for use in accordance with the invention.

Flame retardants and smoke inhibitors which can be used in accordance with the invention include aluminum trihydrate, zinc borate, magnesium hydroxide, antimony trioxide, phosphates and other compounds and compositions which are compatible with the various constituents of the products of the present invention. They are added in effective amounts which will be apparent to this skilled in the art based on manufacturers specifications and code requirements.

### Static Dissipation

In order to adjust the electrical properties of the product of the invention, the formulation of the coating used in each layer and the composition of the substrate may need to modified. The objective is to lower the resistance (raise the conductivity) of the product. Standards and testing procedures for surface to surface and surface to ground resistance for floor coverings are well known in the industry. A preferred range for static dissipative products is 1,000,000 to 1,000,000,000 ohms as tested per ASTM F-150 (standard test method for electrical resistance of conductive floor covering).

In one embodiment of the invention, carbon fibers are incorporated into the substrate to lower its resistance. Antistatic agents that can be added to a latex layer, foamable plastic layer, adhesive layer and/or wearlayers are commercially available and known in the art. Suitable antistatic agents include Nopcostate HS, an ethoxylated composition from Diamond Shamrock and Tebestat IK 12, a nonionic substituted polyether from Dr. Th. Boehme KG, Chem. Fabrik GMBH & Co., 8192 Geretsried 1, Germany. The particular compositions used are not critical as long as they are compatible with the other components present in the floor coverings of the invention. The antistatic agents may be added in various amounts as will be apparent to those skilled in the art depending on recommendations of the manufacturers of said compositions and the desired specifications for the floor covering product.

The following are some examples of preferred embodiments of the invention.

### EXAMPLE 1

An aqueous dispersion is prepared with 12 percent of a water-dispersible cellulose and mixed with 78 percent of diatomaceous earth and 10 percent of polyvinyl acetate. The resulting mixture is colloidally destabilized to form a fibrous agglomerate in aqueous suspension and distributed as a wet web on the wire of a Fourdrinier machine. Variously colored particles of wet laid felt are randomly distributed on the wet web as it is moved along by the wire. The web is then pressed and dried in an oven to make a decorative substrate.

A liquid PVC plastisol is applied in a uniform layer over the decorative substrate using a knife-over roll coater. Heat is then applied to cure the plastisol and fuse it to the substrate.

A floor covering product is thereby produced of the type illustrated in FIG. 1 and it has a random multi-colored appearance.

### EXAMPLE 2

The decorative substrate of Example 1 is coated with a uniform layer of a liquid PVC plastisol and heat is applied to gel the plastisol. A decorative pattern is printed on the plastisol and portions of the pattern permit the underlying elements of the decorative substrate to show through. Another uniform layer of liquid PVC plastisol is coated over the printed layer and heat is then applied to cure the plastisol layers and fuse the product. The product is cooled followed by heating the top layer of plastisol and then subjecting the product to mechanical embossing to produce a floorcovering product of the type illustrated in FIG. 2. The product has a three-dimensional appearance as a result of having two decorative layers separated by a clear plastisol layer.

### EXAMPLE 3

The decorative substrate of Example 1 is coated with a uniform layer of a liquid PVC plastisol and decorative particles are impregnated in the plastisol by conventional means and in a density which permits some of the decorative elements of the substrate to show through the plastisol layer. Heat is then applied to gel the plastisol and another uniform layer of liquid PVC plastisol is coated over the particle containing layer. Heat is then applied to cure the plastisol layers and fuse the product. The product is cooled to about ambient temperature followed by heating the top layer of plastisol and then subjecting the product to mechanical embossing to-produce a floorcovering product of the type illustrated in FIG. 3. The decorative particles provide an appearance of depth to the product.

### EXAMPLE 4

The decorative substrate of Example 1 coated with a gelled plastisol layer containing particles as described in Example 3 is printed with transparent and opaque inks which contain an inhibitor. The printed layer is then coated with a uniform layer of liquid plastisol which contains a blowing agent. The product is heated at a sufficient temperature to activate the blowing agent (and thereby expand the layer containing it) and fuse the product. Then it is cooled followed by heating the top layer of expanded plastisol and then subjecting the product to mechanical embossing to produce a floorcovering product of the type illustrated in FIG. 4. The product has a three-dimensional appearance and multiple decorative elements are visible.

### Example 5

The decorative substrate of Example 1 is coated with a uniform layer of a liquid PVC plastisol and heat is applied to gel the plastisol. Another uniform layer of liquid PVC plastisol containing a blowing agent is coated over the printed layer and heat is then applied to activate the blowing agent (and thereby expand the layer containing it) and fuse the product. The product is then subjected to mechanical embossing to crush portions of the expanded layer and produce a floorcovering product of the type illustrated in FIG. 5.

We claim:

1. A surface covering comprising a wet laid felt sheet having decorative elements incorporated therein and a translucent wearlayer wherein the decorative elements are visible through the wearlayer.

2. The surface covering of claim 1 wherein the wearlayer is clear or tinted.

3. The surface covering of claim 1 further comprising a printed layer overlaying said felt sheet wherein said wearlayer overlays the printed layer and at least a portion of the decorative elements are visible through the printed layer and the wearlayer.

4. The surface covering of claim 3 wherein a translucent plastisol layer is interposed between the printed layer and the felt sheet.

5. The surface covering of claim 4 wherein decorative particles are incorporated in the translucent plastisol layer.

6. The surface covering of claim 1 wherein decorative particles are incorporated in the wearlayer.

7. The surface covering of claim 1 wherein a transparent plastisol layer is interposed between the wearlayer and the felt sheet and decorative particles are incorporated in the plastisol layer.

8. The surface covering of claims 1-7 wherein the wearlayer is mechanically embossed, chemically embossed or chemically and mechanically embossed.

9. A method of manufacturing a surface covering comprising
incorporating decorative elements into a wet laid felt sheet before it is dried and then drying to make a decorative felt sheet,
overlaying the decorative felt sheet with a translucent liquid plastisol and then heating to cure the plastisol and fuse the plastisol with the decorative felt sheet.

10. The method of claim 9 further comprising the step of printing a surface of the decorative felt sheet before overlaying said surface with the translucent wet plastisol wherein the printing permits at least some of the decorative elements to show through.

11. A method of manufacturing a surface covering comprising
incorporating decorative elements into a wet laid felt sheet before it is dried and then drying to make a decorative felt sheet,
overlaying the decorative felt sheet with a first translucent liquid plastisol and then heating to gel the plastisol,
overlaying the gelled plastisol with a second translucent liquid plastisol and then heating to cure the first and second plastisols and fuse them with one another and the decorative felt sheet.

12. The method of claim 11 further comprising the step of applying a printed layer onto the gelled plastisol wherein the printing permits at least some of the decorative elements of the decorative felt sheet to show through.

13. The method of claim 11 further comprising the step of incorporating decorative particles in the first translucent liquid plastisol before heating to gel the plastisol and wherein the particles permit at least some of the decorative elements of the decorative felt sheet to show through.

14. The method of claim 13 further comprising the step of applying a printed layer onto the first plastisol after it is gelled wherein the printing and the particles in combination permit at least some of the decorative elements to show through.

15. The method of claim 14 wherein the printed layer is in the form of a pattern and includes an inhibitor and all or a portion of the printed layer is transparent.

16. The method of claim 15 wherein a portion of the printed layer is opaque.

17. The method of claims 14 or 15 wherein a portion of the printed layer is tinted and translucent.

18. The method of claims 9-16 further comprising the step of mechanical embossing or chemical embossing or chemical and mechanical embossing.

19. The method of claim 17 further comprising the step of mechanical embossing or chemical embossing or chemical and mechanical embossing.
